(19) United States
(12) Patent Application Publication
(10) Pub. No.: US 2020/0132374 A1
(43) Pub. Date: Apr. 30, 2020

(54) Hot Air Flow Direction Control Mechanism of Base Board Baking Machine

(71) Applicant: Tung-Min Lee, Kaohsiung City (TW)

(72) Inventor: Tung-Min Lee, Kaohsiung City (TW)

(21) Appl. No.: 16/170,091

(22) Filed: Oct. 25, 2018

(51) Int. Cl. F27D 7/04; F27D 7/02; G02F 1/13

(52) U.S. Cl. CPC F27D 7/04; G02F 1/1303; F27D 7/02

(57) ABSTRACT

A hot air flow direction control mechanism of a base board baking machine includes a housing, a heated air device and a plurality of air suction units. The heated air device blows heated air, and the air suction units suck and drain the heated air. Thus, the heated air device and the air suction units form an air convection of the heated air, so that the heated air is full of the housing, and the base board is baked evenly and completely.

### BACKGROUND OF THE INVENTION

### 1. Field of the Invention

The present invention relates to a base board baking machine and, more particularly, to a hot air flow direction control mechanism of a base board baking machine.

### 2. Description of the Related Art

A liquid crystal display, such as the TFT-LCD, includes two glass base boards that need to be baked. A conventional base board baking machine in accordance with the prior art shown in FIG. 8 is used to bake a base board 30, and comprises a housing 3 for receiving a hot plate 31 and a heater 311. The hot plate 31 is located above the heater 311. The base board 30 is placed in the housing 3 and located above the hot plate 31. The base board 30 has two edges 301. In operation, the hot plate 31 is heated by the heater 311 so as to heat the base board 30. However, the hot plate 31 cannot keep the base board 30 at a constant temperature during the baking process, thereby decreasing the baking effect of the base board 30, and thereby decreasing the production quality of the base board 30. In addition, the two edges 301 of the base board 30 are easily raised and spaced from the hot plate 31, so that the two edges 301 of the base board 30 are not heated by the hot plate 31, thereby greatly decreasing the quality of the base board 30.

### BRIEF SUMMARY OF THE INVENTION

In accordance with one embodiment of the present invention, there is provided a hot air flow direction control mechanism of a base board baking machine, comprising a stand, a controller mounted on the stand, a housing mounted on a top of the stand, a heated air device mounted in the housing, a plurality of air suction units mounted in the housing, and a top cover mounted on and closing the housing. The heated air device is mounted on an inside of the housing. The air suction units are arranged opposite to the heated air device. The heated air device delivers heated air, and the air suction units suck and drain the heated air, with the heated air device and the air suction units forming an air convection of the heated air, and with the heated air being full of the housing.

In accordance with another embodiment of the present invention, there is provided a hot air flow direction control mechanism of a base board baking machine, comprising a stand, a controller mounted on the stand, a housing mounted on a top of the stand, a plurality of air suction units mounted in the housing, a top cover mounted on and closing the housing, and a heated air device mounted in the top cover. The heated air device is mounted on an inside of the housing. The heated air device blows heated air downward, and the air suction units suck and drain the heated air, with the heated air device and the air suction units forming an air convection of the heated air, and with the heated air being full of the housing, and a periphery of the housing.

Preferably, the air suction units are mounted on a periphery of a bottom plate of the housing, and the air suction units are turned on or turned off to control a flow direction of the heated air, and to drive the heated air to move toward the periphery of the housing.

Preferably, a plurality of temperature sensors are mounted in the housing to control the temperature and regulate the flow rate.

According to the primary advantage of the present invention, the heated air device and the air suction units produce a heat convection to achieve a fully developed heating effect, such that the heated air is full of the housing, and the base board is heated evenly and completely, thereby enhancing the quality of the base board.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hot air flow direction control mechanism of a base board baking machine in accordance with the preferred embodiment of the present invention.

FIG. 2 is a schematic operational view showing flow directions of the heated air of the heated air device as shown in FIG. 1.

FIG. 3 is a perspective view of a hot air flow direction control mechanism of a base board baking machine in accordance with another preferred embodiment of the present invention.

FIG. 4 is a schematic operational view showing flow directions of the heated air of the heated air device as shown in FIG. 3.

FIG. 5 is a schematic cross-sectional view showing flow directions of the heated air of the heated air device as shown in FIG. 3.

FIG. 6 is a perspective view of a hot air flow direction control mechanism of a base board baking machine in accordance with a further preferred embodiment of the present invention.

FIG. 7 is a schematic operational view showing flow directions of the heated air of the heated air device as shown in FIG. 6.

FIG. 8 is a cross-sectional view of a conventional base board baking machine in accordance with the prior art.

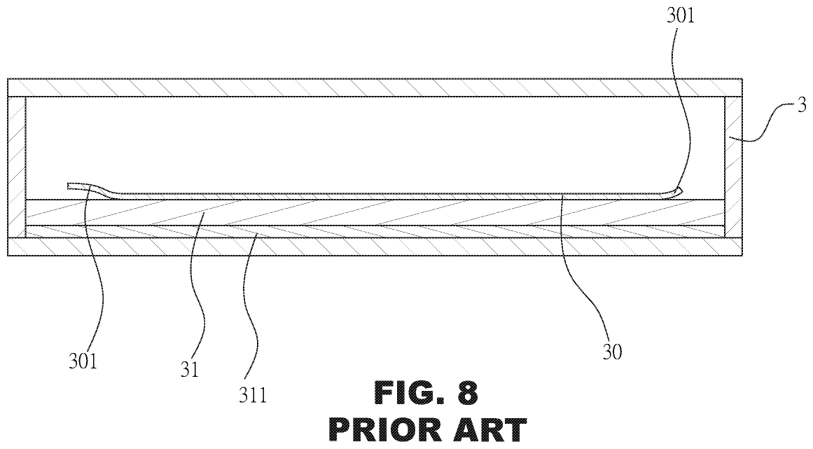

### DETAILED DESCRIPTION OF THE INVENTION

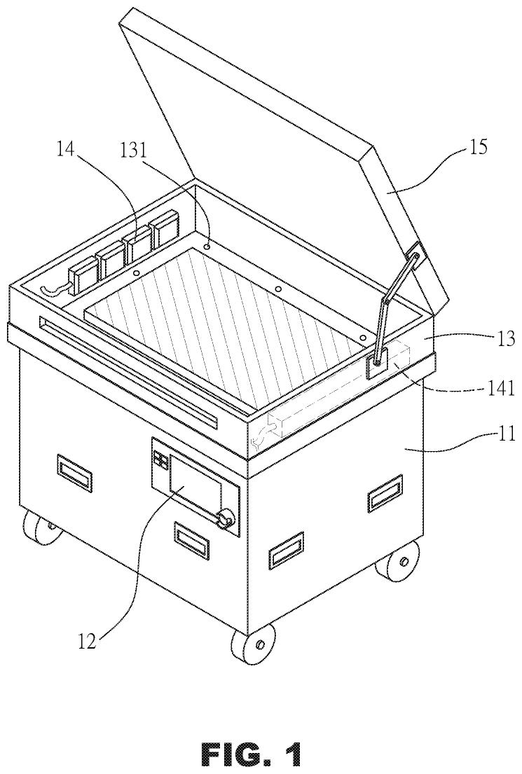

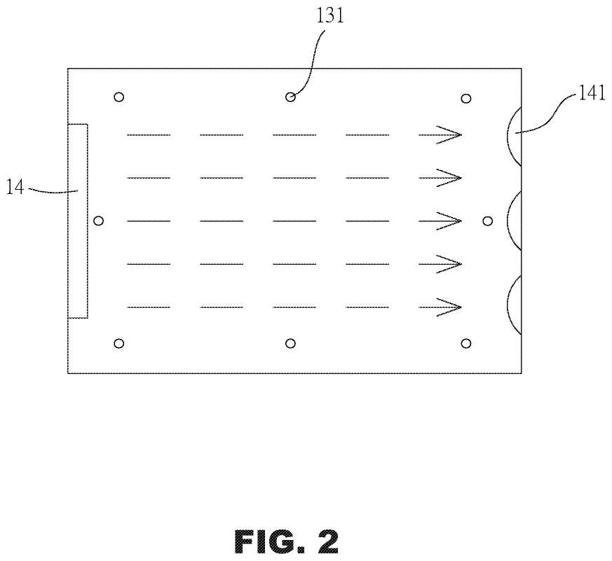

Referring to the drawings and initially to FIGS. 1 and 2, a hot air flow direction control mechanism of a base board baking machine in accordance with the preferred embodiment of the present invention comprises a stand 11, a controller 12 mounted on a side of the stand 11, a housing 13 mounted on a top of the stand 11, a heated air device 14 mounted in the housing 13, a plurality of air suction units 141 mounted in the housing 13, and a top cover 15 pivotally mounted on and closing the housing 13. The heated air device 14 is mounted on an inside of the housing 13. The air suction units 141 are arranged opposite to the heated air device 14. Thus, the heated air device 14 delivers heated air (or hot air), and the air suction units 141 suck and drain the heated air, such that the heated air device 14 and the air suction units 141 form an air convection of the heated air as shown in FIG. 2, to accelerate and expand flow of the heated air, such that the heated air is full of the housing 13. The controller 12 regulates and sets the heated air device 14 at a constant timing, temperature, and flow rate. The controller 12 also turns on/off the air suction units 141. A plurality of temperature sensors 131 are mounted in the housing 13 to control the temperature and regulate the flow rate.

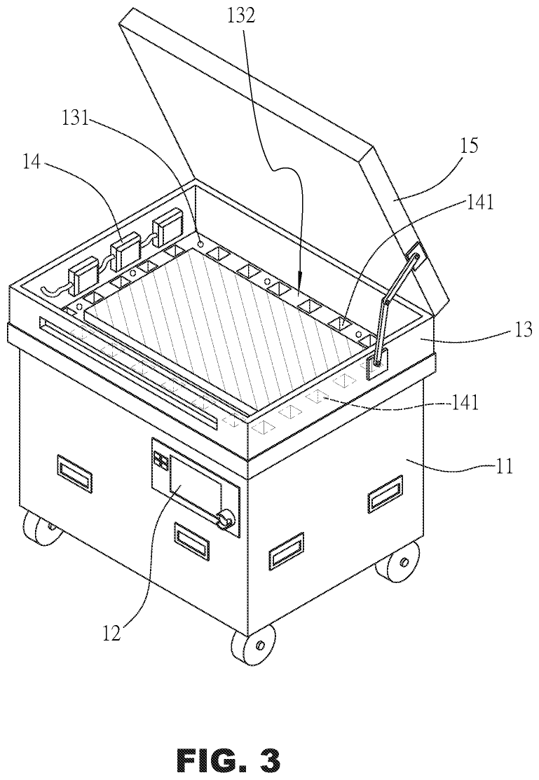

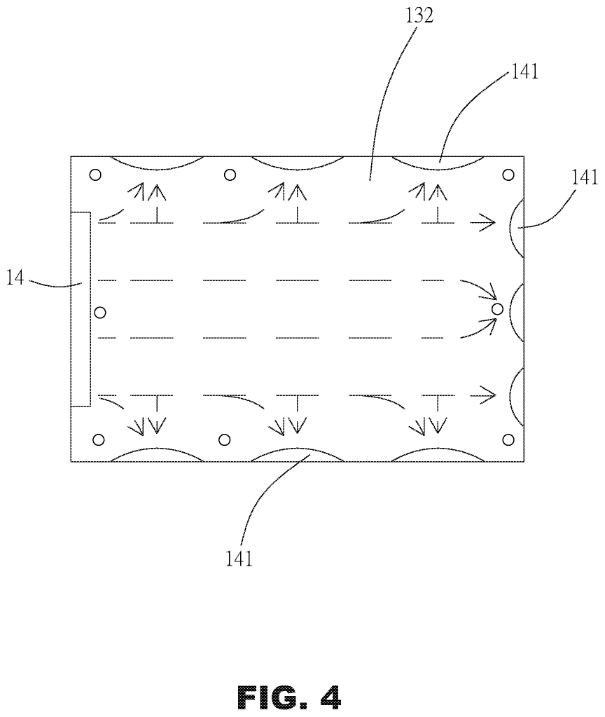

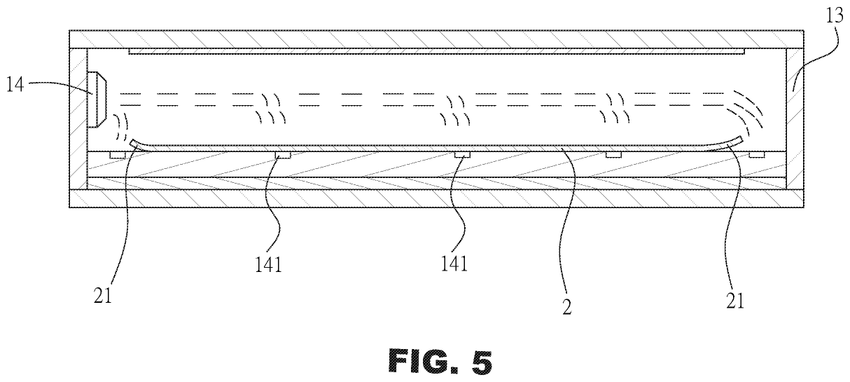

Referring to FIGS. 3-5, the air suction units 141 are mounted on a periphery of a bottom plate 132 of the housing 13 to enhance the heat convection effect. A base board (or base plate or substrate) 2 is mounted in the housing 13 and placed on the bottom plate 132. In such a manner, after the heated air is blown outward from the heated air device 14, the air suction units 141 are adjusted to control the flow direction of the heated air, such that the heated air from the heated air device 14 is blown and moved toward the periphery of the housing 13. Thus, the heated air is distributed evenly in the housing 13 and expanded to reach the corners of the housing 13 at a lower temperature so as to heat the base board 2 completely, such that the two ends 21 of the base board 2 are also heated as shown in FIG. 5. It is appreciated that, the hot air flow direction control mechanism mainly includes the heated air device 14 and the air suction units 141. In such a manner, the heated air is blown from the heated air device 14, and is sucked and drained from the air suction units 141, such that the heated air flows to the periphery of the housing 13 and is full of the housing 13. Thus, the two ends 21 of the base board 2 are heated by the heated air, such that the base board 2 is heated fully.

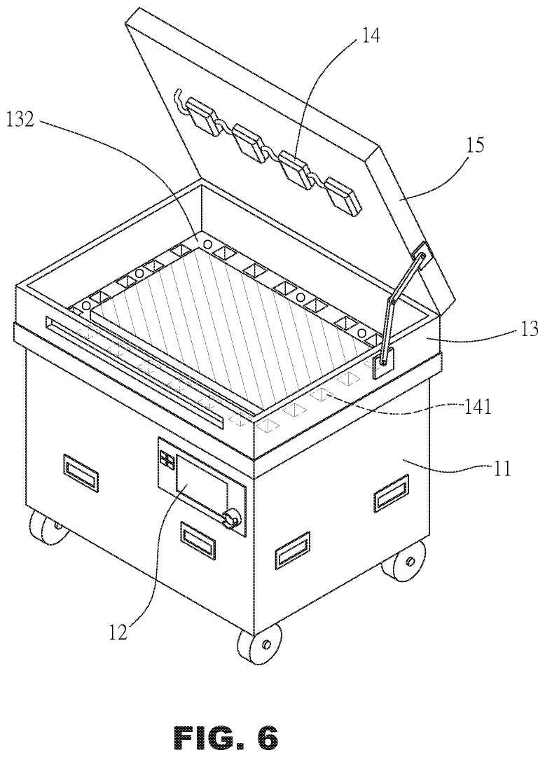

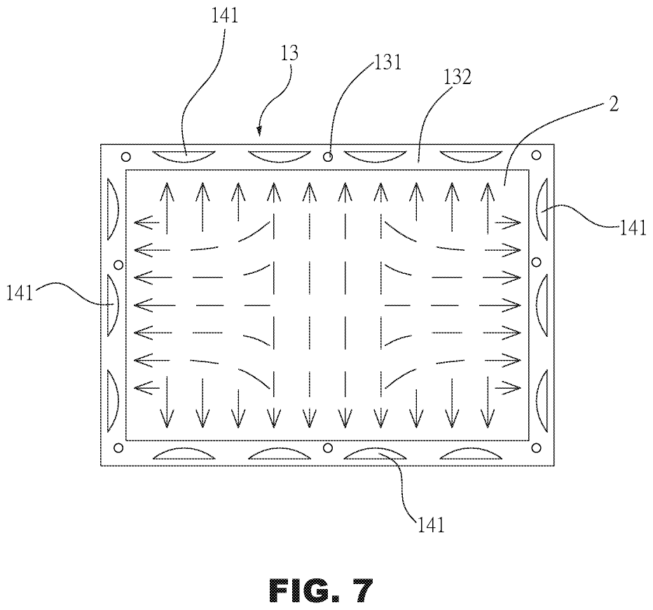

Referring to FIGS. 6 and 7, in accordance with another preferred embodiment of the present invention, the heated air device 14 is mounted on an inside of the top cover 15 to accelerate a full flow of the heated air and to exactly control the direction of the heated air. At the same time, the air suction units 141 are mounted on the periphery of the bottom plate 132 of the housing 13. In addition, the air suction units 141 are turned on or off selectively. In such a manner, when the top cover 15 closes the housing 13, the heated air from the heated air device 14 is blown downward, and when the air suction units 141 are started, the heated air is blown and moved toward the air suction units 141. Thus, when the base board 2 is baked, the temperature at the periphery of the bottom plate 132 is detected, and the air suction units 141 in the region of the periphery are started, to efficiently enhance the heat convection effect in the housing 13, and to increase the temperature at the periphery of the housing 13, so as to achieve a full heat diffusion in the housing 13. Therefore, the raised portion of the two ends 21 (see FIG. 5) of the base board 2 is heated efficiently such that the base board 2 is heated evenly. It is appreciated that, the heated air device 14 is mounted on the inside of the top cover 15, such that the heated air device 14 directly blows the heated air toward the base board 2. In addition, the air suction units 141 are turned on or off according to the preset temperature, such that the heated air compensates the temperature of the two ends 21 of the base board 2, and accelerates flow and diffusion of the heated air.

Again referring to FIGS. 6 and 7, the heated air is blown from the heated air device 14 to heat the base board 2 gradually, and the air suction units 141 surrounding the bottom plate 132 suck and drain the heated air, to produce a heat convection, and to control the flow direction of the heated air. Thus, the heat from the heated air device 14 reaches the corners of the housing 13 such that the whole region of the housing 13 is kept at a constant temperature, and the base board 2 is heated evenly and completely, so as to enhance the quality of the base board 2.

Accordingly, the heated air device 14 and the air suction units 141 produce a heat convection to achieve a fully developed heating effect, such that the heated air is full of the housing 13, and the base board 2 is heated evenly and completely, thereby enhancing the quality of the base board 2. In addition, the heated air device 14 blows the heated air, and the air suction units 141 suck and drain the heated air, to control the flow direction of the heated air during the process of air delivery and air suction, such that the heated air is conducted to all of the corners of the housing 13, so as to heat the raised portion or the two ends 21 of the base board 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A hot air flow direction control mechanism of a base board baking machine, comprising:
a stand;
a controller mounted on the stand;
a housing mounted on a top of the stand;
a heated air device mounted in the housing;
a plurality of air suction units mounted in the housing; and
a top cover mounted on and closing the housing;
wherein:
the heated air device is mounted on an inside of the housing;
the air suction units are arranged opposite to the heated air device; and
the heated air device delivers heated air, and the air suction units suck and drain the heated air, with the heated air device and the air suction units forming an air convection of the heated air, and with the heated air being full of the housing.

2. The hot air flow direction control mechanism of a base board baking machine of claim 1, wherein the air suction units are mounted on a periphery of a bottom plate of the housing, and the air suction units are turned on or turned off to control a flow direction of the heated air, and to drive the heated air to move toward the periphery of the housing.

3. The hot air flow direction control mechanism of a base board baking machine of claim 1, wherein a plurality of temperature sensors are mounted in the housing to control the temperature and regulate the flow rate.

4. A hot air flow direction control mechanism of a base board baking machine, comprising:
a stand;
a controller mounted on the stand;
a housing mounted on a top of the stand;
a plurality of air suction units mounted in the housing;
a top cover mounted on and closing the housing; and
a heated air device mounted in the top cover;
wherein:
the heated air device is mounted on an inside of the housing;
the heated air device blows heated air downward, and the air suction units suck and drain the heated air, with the heated air device and the air suction units forming an air convection of the heated air, and with the heated air being full of the housing, and a periphery of the housing.

5. The hot air flow direction control mechanism of a base board baking machine of claim 4, wherein the air suction units are mounted on a periphery of a bottom plate of the housing, and the air suction units are turned on or turned off to control a flow direction of the heated air, and to drive the heated air to move toward the periphery of the housing.

6. The hot air flow direction control mechanism of a base board baking machine of claim 4, wherein a plurality of temperature sensors are mounted in the housing to control the temperature and regulate the flow rate.
